(19) United States
(12) Patent Application Publication
(10) Pub. No.: US 2012/0144032 A1
(43) Pub. Date: Jun. 7, 2012

(54) Monitoring System

(76) Inventor: Dale Read, Essex (GB)

(21) Appl. No.: 13/391,161

(22) PCT Filed: Aug. 24, 2010
(86) PCT No.: PCT/GB10/51394

§ 371 Date: Feb. 21, 2012

(30) Foreign Application Priority Data
Aug. 24, 2009 (GB) 0914705.9

(51) Int. Cl. G06F 15/173; H04W 24/00

(52) U.S. Cl. 709/224

(57) ABSTRACT

A monitoring unit having at least one interface to receive information from at least one device to be monitored, the monitoring unit further having a data transmitter operable wirelessly to communicate information relating to the at least one device to a remote server, accessible by a user remote from the server.

THE PRESENT invention relates to a monitoring system and, more particularly, a monitoring system comprising a monitoring unit operable to receive information from at least one device being monitored and transmit the information wirelessly to a remote server of the system. The present invention further provides a method of remotely monitoring at least one device.

Systems for monitoring the performance and/or attributes of a device are known, and the field of technology is often referred to as “telemetry”. Information relating to the device may be gathered periodically and stored within a memory of the device for future use and/or analysis. When information relating to a particular device is required, the user may access the information stored in the device's memory. The device being monitored may automatically print out or display some or all of the information collected, so that the user may retrieve the print-out or view the information displayed, without having to access the information in the memory.

The device being monitored may comprise an audible or visual alarm, which is activated when there is a fault with the device, or when a particular attribute of the device is no longer within a predetermined range. Some industrial plant have a “traffic light” alarm system mounted atop the device, providing users or operators within audible or visual range of the device with an indication that the device is operating satisfactorily or that the device needs attention.

A problem with such prior art systems is that a user has to visit the device to retrieve the information relating to the device. Even in the case of the device being provided with an alarm, the user still needs to be in audible or visual range of the device. When a plurality of devices are being monitored, it may be impractical to visit each device with the necessary frequency to ensure that the device is operating as required. By the time the information relating to a fault is retrieved or acknowledged by the user, the device may have malfunctioned as a result of the earlier fault, and in any event, the information may be out of date and have expired.

Where a plurality of devices to be monitored are arranged in a local group (cell), a local monitoring unit may be provided, which is hard-wired to each of the devices being monitored in that cell, which may only be a few metres apart (for example a cell of manufacturing machines). The user can then retrieve information relating to any one or all of the devices (or the cell as a unit) from the local monitoring unit. However, because of the hard-wired connection, such local monitoring units can only be used where there is a plurality of devices relatively local to one another—e.g. on the same site or section of a site. Where devices are geographically distant from one another, on separate sites, the user must still visit each device site to retrieve information relating to the devices.

It is possible, in some situations, to provide a central monitoring system, which is hard-wired to all of the devices to be monitored, either directly or via a local monitoring unit, so that the central monitoring system can request and compile information from all the devices. However, hard-wiring the devices (or local monitoring units), to the central monitoring system, is very expensive. Moreover, where devices are distributed over large areas, it is sometimes physically and economically infeasible to provide a hard-wired connection between all the devices and the central monitoring system. The user must still therefore visit the remote sites to retrieve information.

As an alternative to installing a dedicated hard-wired connection network, it is possible to utilise the existing fixed line telecommunications infrastructure to communicate information relating to a device to the central monitoring system. In such situations, the device site is provided with a dial-up telephone connection point. Information can then be sent down the telephone line and received at the other end by the central monitoring system.

One problem with this arrangement, however, is that the fixed landline telecommunication system was only ever envisaged to carry voice data to and from users. When a connection between two users is established, the line of communication is necessarily left permanently open, so that the two users may speak to one another in real time. When the users have finished a conversation, the line is disconnected.

When using the fixed line telecommunications network to monitor a remote device, information may be received from the remote device at predetermined intervals, or as an alarm signal is generated. Accordingly, the line must be left permanently open, so that the information relating to the devices may be communicated to the central monitoring system when generated. However, leaving a line permanently open is expensive, as it will attract usage charges for every unit of time the line is open, while only being utilised for a portion of that time.

Alternatively, to reduce running costs, the connection may be terminated when information is not being communicated. However, when information later needs to be communicated to the central monitoring unit, the line must be re-established. The delay in making such a communication may mean the information, when sent to the central monitoring unit, may have expired and no longer be of relevance, due to the lag. In the case of an alarm signal, the device may have malfunctioned by the time the information is received by the central monitoring unit and by the time action can be taken.

There is a need, therefore, for an improved monitoring unit and associated system.

Accordingly, the present invention provides a monitoring system comprising:
a monitoring unit comprising at least one interlace to receive information from at least one device to be monitored, the monitoring unit further comprising a data transmitter; and
an SQL server, accessible by a user remote from the server,
wherein the data transmitter of the monitoring unit is operable wirelessly to automatically push information relating to the at least one device to the remote SQL server.

Preferably, at least one interlace is provided by a terminal connection socket.

Advantageously, the at least one interface is operable to receive serial information from the at least one device to be monitored.

Conveniently, the monitoring system comprises a plurality of interfaces, each operable to receive information from a respective one of a plurality of devices to be monitored.

Preferably, the monitoring system further comprises a processor operable to perform at least one analysis on the information received and, based on that analysis, selectively communicate information relating to at least one device to the remote SQL server.

Advantageously, the data transmitter is operable to communicate information serially.

Conveniently, the data transmitter is operable to communicate information using an existing wireless telecommunication network.

Preferably, the data transmitter is operable to communicate information via GPRS.

Advantageously, the monitoring unit is operable to draw power from at least one of the devices to be monitored.

Conveniently, the monitoring system further comprises a remote user interface, configured to selectively access information stored on the remote SQL server.

Preferably, the remote monitoring system is connected to a wireless telecommunications system.

The present invention further provides a method of remotely monitoring at least one device, comprising:
providing a monitoring unit comprising at least one interface and a data transmitter;
providing an SQL server;
receiving information from the at least one device at the at least one interface; and
wirelessly and automatically communicating information relating to the at least one device using the data transmitter, to the remote SQL server, accessible by a user remote from the server.

The embodiments of the present invention will now be described, by way of example only, with reference to the figures in which:

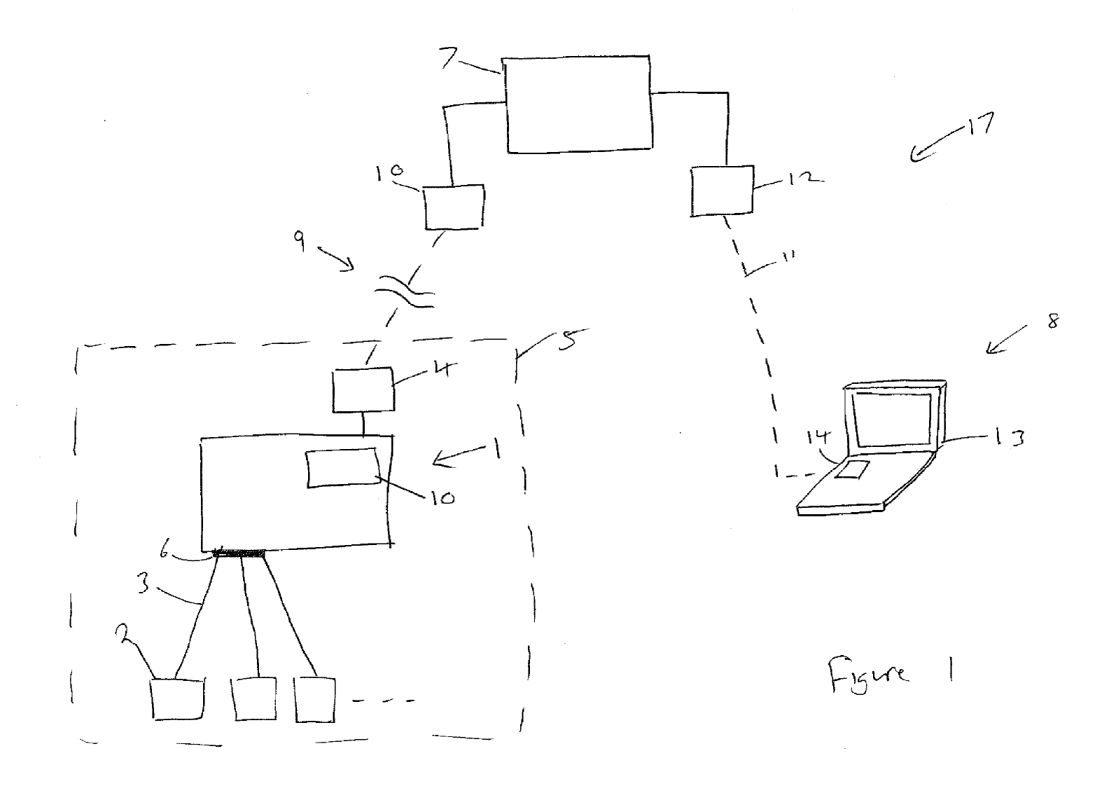

FIG. 1 is a schematic representation of a monitoring unit embodying the present invention, incorporated within a remote monitoring system also embodying the present invention; and

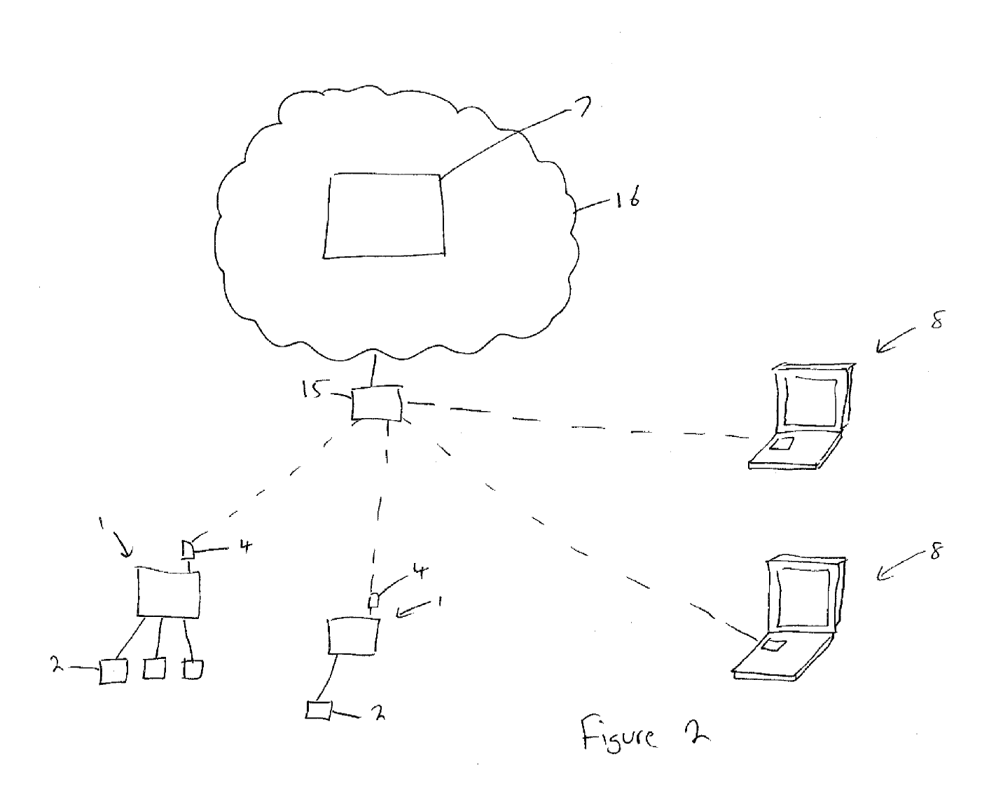

FIG. 2 is a schematic representation of a remote monitoring system embodying the present invention.

FIG. 1 illustrates a monitoring unit comprising at least one interface to receive information from at least one device to be monitored.

The monitoring unit 1 schematically illustrated in FIG. 1 is shown connected to three devices 2 to be monitored, by a wired connection 3. A monitoring unit 1 embodying the present invention is operable to monitor a single device 2 or a plurality of devices 2. The number of devices 2 able to be monitored by a single monitoring unit 1 may depend on, inter alia, the information required to be monitored, the frequency of the monitoring, and the bandwidth of the data transmitter 4.

In the embodiment shown in FIG. 1, each of the devices 2 being monitored is hard-wired 3 to the monitoring unit because the devices illustrated are local to the monitoring unit. Alternatively, or additionally, at least one of the devices 3 being monitored may be connected to the monitoring unit using an existing communications infrastructure. For example, the site 5 at which the devices 3 and monitoring units 1 are located may have an existing internal telecommunications network, which can be utilised to communicate information from the devices 2 to the monitoring unit 1. In one embodiment, a device 2 may communicate information to the monitoring unit 1 using an existing communications bus installed at the site. In another embodiment, information may even be transmitted using an electrically-conductive services infrastructure (i.e. the heating pipe network) located on the site 5.

In one embodiment, the device 2 may be fitted with a wireless transmitter (not shown), which transmits information to a corresponding wireless receiver (not shown) provided by or connected to the monitoring unit 1. The wireless receiver of the monitoring unit 1 may the same, or form part of, the data transmitter 4 (to be described below).

In any event, the monitoring unit 1 is operable to receive information from at least one device 2, to be monitored, through an interface 6.

The interface 6 between the monitoring unit 1 and device(s) 2 may comprise a terminal connection socket. In one embodiment, the monitoring unit 1 comprises a plurality of interfaces 6, each to be connected to a respective device 2. Alternatively, the interface 6 may comprise a terminal connection socket having a plurality of sockets. In one embodiment, the terminal connection socket is a serial socket, for connection to a serial bus which is, in turn, connected to a PLC of a device 2, or devices 2, being monitored.

In one embodiment, the interface 6 is operable to communicate with a device 2 being monitored by at least one of the protocols of serial, Ethernet, slice, USB, modbus or any other applicable communications protocol.

The monitoring unit 1 further comprises a data transmitter 4 operable wirelessly to communicate information relating to the at least one device 2 to a remote server 7, accessible by a user 8 remote from the server 7. The data transmitter 4 is operable to communicate via an existing wireless telecommunications network 9, for example a cellular telephone network.

Accordingly, by using an existing wireless telecommunications network 9, there is no need to install a dedicated, hard-wired, connection to a device 2, avoiding the high installation costs associated therewith. Still further, by using wireless communication, the monitoring unit 1 is operable to communicate information from remote devices 2, regardless of the terrain between the device 2 and the remote server 7.

The monitoring unit 1 is configured to automatically ‘push’ information from the device(s) 2 being monitored to the remote SQL server. A monitoring system embodying the present invention comprises a plurality of monitoring units, each configured to push information from the devices to the remote SQL server. An advantage of such a system is that there is no reliance on the SQL server “pulling” the information from the monitoring units. If the SQL server was to ‘pull’ the information from the monitoring units, central failure of the SQL server or its control system would cause failure of the entire monitoring system, as no information would be caused to be received from any of the monitoring units. It will be appreciated that such susceptibility to failure in a monitoring system is not acceptable.

With a monitoring system embodying the present invention, since each monitoring unit is configured to push information to the server, failure of the monitoring unit would only cause the information monitored by that monitoring unit not to be sent to the server. All other monitoring units would continue to send information to the server, as normal. A monitoring system embodying the present invention is therefore substantially fail-safe, at least to the extent that the effects of a fault with a monitoring unit are confined only to that monitoring unit.

Information may be pushed from the monitoring unit to the server at predetermined intervals and/or when predetermined conditions have been met, which intervals and conditions are configured in the monitoring unit 1. The predetermined intervals may be selectively configurable by a user for a given monitoring unit, or for a single or set of devices 2 being monitored. For example, some information relating to a device 2 may be pushed at more regular intervals than other information relating to that device 2. Likewise, information relating to some devices 2 may be pushed to the server more regularly than information relating to other devices 2.

A further benefit of pushing information from the monitoring device is that only information of any deemed relevance need to pushed to the remote server. For example, suppose that a device being monitored was an escalator, information of particular concern to a user would be when the escalator malfunctions. By providing a monitoring unit embodying the present invention, information need only be pushed to the server when a malfunction is known to have occurred. This is because the monitoring unit directly connected to the device and thus knows when a malfunction or a predetermined condition has occurred.

If information was instead to be pulled from the monitoring unit to the server, the server would need to request information from the monitoring unit at predetermined intervals, the majority of which occasions would report that there is no malfunction. Sending such information may be deemed uneconomical, both in terms of usage of the wireless interface between the monitoring device and the server; and of storing information in the server which has little or no use. Moreover, by pulling information at predetermined intervals, the information reporting a malfunction will likely be received by the server some time after the malfunction as occurred. With the present invention, information can be sent as the malfunction occurs, and only when the malfunction (or a predetermined condition) occurs.

Another benefit of the monitoring unit of the system being configured to push information to the server is that the system is scalable, without reconfiguration of the server being required. If the server was to pull information, it would need to be reconfigured also to pull information from any newly added monitoring units. Such reconfiguration is inconvenient. With the present invention, each monitoring unit automatically pushes information to the server. The server is preconfigured to receive information from monitoring units and does not need to be reconfigured to be able to receive information from a newly added monitoring unit.

In one embodiment, the monitoring unit is configured to pull information from the remote device(s). In another embodiment, a device being monitored is configured to push information to the monitoring unit. For a given monitoring unit, information from some devices being monitored may be pulled by the monitoring unit. In another embodiment, information from devices being monitored may be pushed to the monitoring unit. In one embodiment, information from devices being monitored may be both pulled by and pushed to the monitoring unit connected to the devices.

In another embodiment, the monitoring unit 1 comprises a processor 10, which is operable to perform at least one analysis on the information received and, based on that analysis, selectively communicate (push) information relating to the devices 2 to the remote server 7. For example, a device 2 may report its status, relating to a particular information field, to the monitoring unit 1 at predetermined intervals.

Similarly, the processor 10 may be configured so as only to communicate information relating to a device 2 when the information falls outside/inside of a predetermined range.

The processor 10 is operable to convert the information received from the devices 2 into information which may then be communicated using the data transmitter 4 to the server 7.

The monitoring unit 1 is operable to convert information to a SQL data stream. The remote server 7 is configured with an SQL database, so as to receive and store the SQL data received from the data transmitter 4 of the monitoring unit. Preferably, the monitoring unit 1 is operable to connect to a wireless telecommunications network 9 which is configured to transmit such a format of data.

The data transmitter 4 is operable wirelessly to communicate information to the remote server 7, by at least one of the protocols of GPRS, EDGE or G3 or any other suitable data communication protocols.

The use of GPRS, EDGE and G3 as wireless communications protocols has significant advantages over, for example, GSM, since they are specifically adapted to transmit information in an economical way. By comparison, the GSM protocol is primarily configured to transmit voice data and is not suited to transmit large volumes of non-voice information. The GSM protocol allows the transmission of only limited data in small packages, using the Short Messaging Service (SMS). SMS is not a suitable wireless protocol for a monitoring system embodying the present invention.

Yet another particular benefit of the present invention is that, should a part of the telecommunications network between the monitoring unit and the server be down, the information pushed by the monitoring unit is stored by the network and resent when the network is restored. The monitoring unit does not need to ‘re-push’ the information.

A particular benefit of the use of such telecommunication protocols is that they are well suited to the transmission of serial information such as that of the SQL protocol.

Moreover, when transmitting data through a wireless telecommunications network 9, the network operator only charges the user for the amount of information transmitted therethrough. Accordingly, when no information is being transmitted, there will be no usage costs associated with leaving the line ‘open’. The user therefore only pays for the data sent and thus, unlike with a fixed line telecommunications system, does need to pay for every unit of time the line is ‘open’. Moreover, because the line is left permanently open, information may be communicated without needing to make a connection.

The information wirelessly transmitted from the monitoring unit 1 may be stored in an SQL database of a remote server 7 without further manipulation or processing of the information required. Preferably, the wireless telecommunications network 9 includes a connection to the internet. Conveniently, therefore, the data transmitter 4 may communicate information by connection to an existing wireless telecommunications network and utilising the connection of the wireless telecommunications network to the internet to send the information to an SQL database configured on a remote server 7. The remote server 7 may be hosted by a third party, or may be located on the premises of the organisation monitoring the plurality of devices 2, and connected to the internet.

Information stored on the remote server 7, for example in the SQL database, may then be accessed by a user, for information and/or further analysis. The user may access the remote server 7 using the internet or, if the user 8 is in the vicinity of the server 7, the user 8 may access the information by a hard-wired connection to the server.

In another embodiment, the user 8 may access the server 7 remotely, for example via a GPRS (or other suitable) connection to the server. Advantageously, a user 8 may then access the information stored on the server 7 from a plurality of geographic locations.

In FIG. 1, the wireless data transmitter 4 of the monitoring unit 1 is shown to communicate with a wireless data receiver 10 connected to the remote server 7. The wireless data receiver 10 may form a part of the wireless telecommunications network 9. Also in FIG. 1, a connection 11 is shown between the user 8 and the remote server 7. Information is sent by a wireless transmitter 12 and received by the user 8. In FIG. 1, the user 8 may receive the information on a laptop computer 13, having an integral wireless receiver 14.

In one embodiment, shown schematically in FIG. 2 there is a wireless data transceiver 15 connected to the server, which is operable to communicate with both a monitoring unit 1 and a user 8. In FIG. 2, the cloud 16 denotes the internet, to which the server 7 is connected or forms a part thereof.

Preferably, there is a two-way connection between the user 8 and the remote server 7. Accordingly, the user 8 may send a request to the server 7 to be provided with particular information, and the server 7 then sends that information back to the user 8. Advantageously, there is also a two-way connection between the monitoring unit 1 and remote server 7. Accordingly, the server 7 may—on the instruction of the user 8—request information from the monitoring unit 1 which, in response, communicates that information to the server 7, which may then be received by the user 8. With an embodiment of the present invention, a user 8 may be located at the site 5 of a device 2 in use and, using a remote user interface 13, such as a laptop, with a wireless receiver 14, access the information stored on the remote server 7 relating to at least one of those devices 2. The location of the remote server 7, as compared to that of the device 2 and user 8, is irrelevant, so long as the monitoring unit 1 is operable to send information to the remote server 7; and the user 8 is able to access information stored on the remote server 7.

Information accessed on the server 7 by the user 8 may be delivered to the user 8 by ways of a graphical user interlace (GUI) provided on or by the remote user interface 13. The GUI may take the form of a Scada package. The GUI may be user-configurable, so that the user 8 may view only some of the information stored on the remote server 7. In one embodiment, the GUI forms part of a software program loaded into the memory of a personal computer. The program may be operable to perform at least one operation on the information received before displaying the information to the user 8.

The server may store the information in the form of a WWW page viewable on the remote user interface. Such an arrangement has significant advantages over the use of TCP/IP addresses. In an embodiment of the present invention, the control system for the GPRS data transmitter is configured to process information such that it can be configured to be accessed via a www page.

The monitoring unit 1 embodying the present invention is operable to receive information from a plurality of different types of device 2. The device may comprise any type of monitorable plant, for example a generator, conveyor-belt, machine, lift, escalator, energy meter and HVAC monitoring systems, among many others. The device 2 could also be one of a plurality of sensors, such as a temperature sensor, pressure sensor, moisture sensor, proximity sensor etc.

A particular benefit of a monitoring unit 1, and remote monitoring system, embodying the present invention is that a user can access information within a relatively short period of it having been received from the device 2 by the monitoring unit 1. In one embodiment, the “lag” from when information is generated from a device 2, and when it is presented to a user 8, may be in the range of 1 to 10 seconds. Preferably, the range is between 3 to 8 seconds. It will be appreciated that a user may therefore monitor a plurality of devices substantially in “real time”, without any appreciable lag which would have any real bearing on the usefulness of the information.

One practical application of a monitoring unit 1 embodying the present invention is in monitoring the status of a passenger lift. A list of the devices 2 associated with a lift which may be monitored is as follows:
the lift “call” buttons provided on each floor;
the lift operation panel provided in the lift car;
an occupancy detector;
a light gate at the entrance/exit of the lift car, to determine passengers entering/leaving;
control units for the or each lift motor;
temperature probes in bearings associated with the lift hoisting mechanism;
temperature sensors associated with the lift motors
torque sensors associated with each of the drive shafts;
temperature sensor inside the lift car;
linear position sensor.

By monitoring at least the above listed parameters, the position and status of the lift car may be monitored remotely by a user substantially in real time. When a particular parameter changes to a predetermined state, or falls outside or inside of a predetermined range, additional information (for example an alarm) may be sent (pushed) from the monitoring unit 1 to the remote server 7. Alternatively or additionally, the software program associated with the GUI may carry out an analysis on the information and interpret this information for the user 8. For example, if one of the devices 2 being monitored is a linear position sensor, configured to detect the precise position of the lift car at any one moment, the GUI may provide the user with a graphical representation of the lift-shaft, showing the position of the lift car in the lift-shaft at any one time.

By monitoring the information received from at least one device 2, embodiments of the present invention may extrapolate the information received to determine, for example, when the device 2 being monitored is likely to malfunction and/or require maintenance. Conveniently, by remotely monitoring a plurality of devices 2, the present invention may highlight devices 2 which are likely to malfunction and/or need maintenance well in advance of such an event occurring or service being required. The downtime associated with any malfunctioning devices may therefore be reduced.

In one embodiment, the monitoring unit 1 of the present invention is operable to receive PLC-type (e.g. SCADA) data from a device 2 and to convert the data into a SQL data stream, which is communicated wirelessly to the server 7. In one embodiment, the server is configured with a web page, to which the SQL data is communicated via https, SSL-encrypted links protected by php. The user than access the webpage remotely.

The present invention further provides a remote monitoring system 17 comprising a monitoring unit 1 comprising at least one interface 6 to receive information from at least one device 2 to be monitored, the monitoring unit 1 further comprising a data transmitter 4 operable wirelessly to communicate information relating to the at least one device 2; a least one remote server 7, configured to store information transmitted wirelessly from the data transmitter 4; a remote user interface 13, configured to selectively access information stored on the remote server 7.

Still further, the present invention provides a method of remotely monitoring at least one device 2, comprising providing a monitoring unit 1 comprising at least one interface 6 and a data transmitter 4; receiving information from the at least one device 2 at the at least one interface 6; and wirelessly communicating information relating to the at least one device 2 using the data transmitter 4, to a remote server 7, accessible by a user 8 remote from the server 7.

Further, the present invention provides a method of operating a remote monitoring system 17, comprising providing a monitoring unit 1 comprising at least one interface 6 and a data transmitter 4; receiving information from the at least one device 2 at the at least one interface 6; providing a server 7, remote from the monitoring unit 1; wirelessly communicating information relating to the at least one device 2 using the data transmitter, to the remote server 7; providing a remote user interface; using the remote user interface 13 to selectively access information stored on the remote server 7.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A monitoring system comprising:
a monitoring unit comprising at least one interface to receive information from at least one device to be monitored, the monitoring unit further comprising a data transmitter; and
an SQL server, accessible by a user remote from the server in substantially real time,
wherein the data transmitter of the monitoring unit is operable to communicate information wirelessly via GPRS to automatically push information relating to the at least one device to the remote SQL server in substantially real time,
wherein the monitoring system is configured to provide substantially real time two-way communication of data between the monitoring unit and the SOL server, and substantially real time two-way communication of data between the SOL server and the user remote from the server.

2. A monitoring system according to claim 1, wherein the at least one interface is provided by a terminal connection socket.

3. A monitoring system according to claim 1, wherein the at least one interface is operable to receive serial information from the at least one device to be monitored.

4. A monitoring system according to claim 1, comprising a plurality of interfaces, each operable to receive information from a respective one of a plurality of devices to be monitored.

5. A monitoring system according to claim 1, further comprising a processor operable to perform at least one analysis on the information received and, based on that analysis, selectively communicate information relating to at least one device to the remote SQL server.

6. A monitoring system according to claim 1, wherein the data transmitter is operable to communicate information serially.

7. A monitoring system according to claim 1, wherein the data transmitter is operable to communicate information using an existing wireless telecommunication network.

8. (canceled)

9. A monitoring system according to claim 1, wherein the monitoring unit is operable to draw power from at least one of the devices to be monitored.

10. A monitoring system according to claim 1, further comprising a remote user interface, configured to selectively access information stored on the remote SQL server.

11. A remote monitoring system according to claim 10, wherein the remote monitoring system is connected to a wireless telecommunications system.

12. A method of remotely monitoring at least one device, comprising:
providing a monitoring unit comprising at least one interface and a data transmitter;
providing an SQL server;
receiving information from the at least one device at the at least one interface,
wirelessly and automatically communicating information, in substantially real time, relating to the at least one device using the data transmitter, to the remote SQL server, accessible by a user remote from the server in substantially real time; and
configuring the monitoring system to provide substantially real time two-way communication of data between the monitoring unit and the SOL server via GPRS, and substantially real time two-way communication of data between the SOL server and the user remote from the server.

13. (canceled)
